(19) United States
(12) Patent Application Publication
(10) Pub. No.: US 2015/0074998 A1
(43) Pub. Date: Mar. 19, 2015

(54) METHOD FOR IMPROVING THE QUALITY OF THE SURFACES OF CRANKSHAFTS

(71) Applicants: Jandrey Maldaner, Roetgen (DE); Alfred Heimann, Aachen (DE)

(72) Inventors: Jandrey Maldaner, Roetgen (DE); Alfred Heimann, Aachen (DE)

(73) Assignee: HEGENSCHEIDT-MFD GMBH & CO. KG, Erkelenz (DE)

(21) Appl. No.: 14/344,263

(22) PCT Filed: Sep. 14, 2012
(86) PCT No.: PCT/DE2012/000915

§ 371 Date: Oct. 24, 2014

(30) Foreign Application Priority Data
Sep. 16, 2011 (DE) 10 2011 113 801.7

(51) Int. Cl. B23K 26/00; B24B 39/04; F16C 3/06; B23P 9/02; B23P 25/00

(52) U.S. Cl. CPC B23K 26/0093; B23P 9/02; B23P 25/006; F16C 3/06; B23K 26/0066; B24B 39/04
USPC 29/888.08; 219/121.69; 451/49

(57) ABSTRACT

The invention relates to a method for machining surfaces of the bearing seats of main and pin bearings on crankshafts made of cast steel following the machining of surfaces with an undefined cutting edge by grinding or finishing. The problem of improving the quality of the running surfaces of the bearings of hardened or unhardened crankshafts is solved. This is achieved by irradiating the surfaces with a laser beam.

### CROSS-REFERENCE TO RELATED APPLICATIONS

This is a U.S. National Phase Application under 37 CFR 371 of PCT/DE2012/000915, filed Sep. 14, 2012 and published in German as WO/2013/037353 on Mar. 21, 2013. This application claims priority to German Application No. 10 2011 113 801.7, filed Sep. 16, 2011. The disclosures of the above applications are incorporated herein by reference.

### FIELD

The invention is a process for improving the surface quality of the main and pin bearings of stainless steel crankshafts after the bearing running surfaces have been ground or finished.

### BACKGROUND AND SUMMARY

Crankshafts in car engines are mass-produced parts whose quantities stretch into the millions. Forged steel crankshafts are used in for high-load applications, e.g. in diesel engines. Stainless steel crankshafts have much lower manufacturing costs and are used for engines with normal loads. The progress in engine development has led to higher gas forces and thus greater being placed on crankshafts, while at the same time bearings have been downsized for reasons of energy consumption. As such, the load capacity of bearings on stainless steel crankshafts is increasingly being used up.

The surface of the casting material of the bearings—especially the pin bearings—is now largely unsuited to use with high specific bearing loads. During bearing operation, the lids above the graphite balls in the casting material—known as spherulites—open, damaging the slide bearing shells of the counter-running surface. High-load bearings are sometimes used in the field of mixed friction, and the way that the engines of modern vehicles usually cut out when there is no load—start-stop cycling—causes additional wear on the bearings. Mathematically, the bearing gap when the engine is running is in the range of up to below 1 μm. This emphasizes the need for high geometrical precision and minimum roughness. High-load bearings have very precise geometrical forms, and the bearing shells' chemical affinity to metal means that they need a martensitic surface and very low surface roughness. A hardened running surface gives the bearing an advantage in terms of load capacity during the transport and handling of the crankshaft. In order to use this advantage, only a very low hardening depth of around 1/10 mm.

The micro-surface structure of bearing running surfaces made of GJS is characterised by spherulites. If these spherulites are then cut while the bonded grain is being machined, e.g. during grinding, this generates the steel jackets, known as lids. The term “lid” refers to the thin metal residue that remains on the surface when a spherulite is cut. These may come loose when placed under load, resulting in much greater wear on the bearing running surface. If the lids are removed, loose particles will no longer be able to damage the bearing running surfaces later on when the crankshaft is installed and under load.

The belt finishing process that is usually used for bearing machining in the crankshaft production line is generally split into two stages, with a coarser grain to remove the lids and a finer grain to reduce the surface roughness. However, because of how the process works, belt finishing is unable to completely remove the lids from above the spherulites that are close to the surface.

As such, the task of this invention is to improve the quality of the running surfaces of main and pin bearings on hardened or unhardened stainless steel crankshafts following grinding and finishing, thus increasing the service life of combustion engines.

A laser is used to remove the lids from the bearing running surfaces. The irradiation evaporates/melts the lids above the graphite inclusions, thus removing the lids and freeing up the graphite inclusions. At the same time, the laser beam creates a thin hard layer on the ferritic, pearlitic matrix of the base material. The laser machining can be carried out as a single-stage process where simultaneous lid removal and hardening is sufficient or as a two-stage process where hardening takes place after removal.

The roughness of the lids removed using the laser and the bearing running surfaces that are subsequently hardened with a thin layer is reduced by finishing rolling. This is a cost-effective process, and is highly environmentally friendly when compared to belt finishing under oil. The lasered surface is re-shaped and smoothed under high pressure by a carbide rolling tool.

Finish-rolled surfaces are characterised by a low depth of roughness, and have no protruding points. Finish rolling does not create aggressive surfaces, for example, so the wear during the engine's start-up phase is lower. This shortens the engine's start-up phase and reduces the wear on the bearings. The sliding bearing shells on the counter-running surfaces thus enjoy a longer service life.

### DRAWINGS

The invention is described in detail below using a design example. The following views, each in enlarged scale, show:

FIG. 1: depicts a ground section of the surface of a main or pin bearing on a stainless steel crankshaft;

FIG. 2: depicts a lasered section of the surface of a main or pin bearing on a stainless steel crankshaft; and

FIG. 3: depicts a finish-rolled section of the surface of a main or pin bearing on a stainless steel crankshaft.

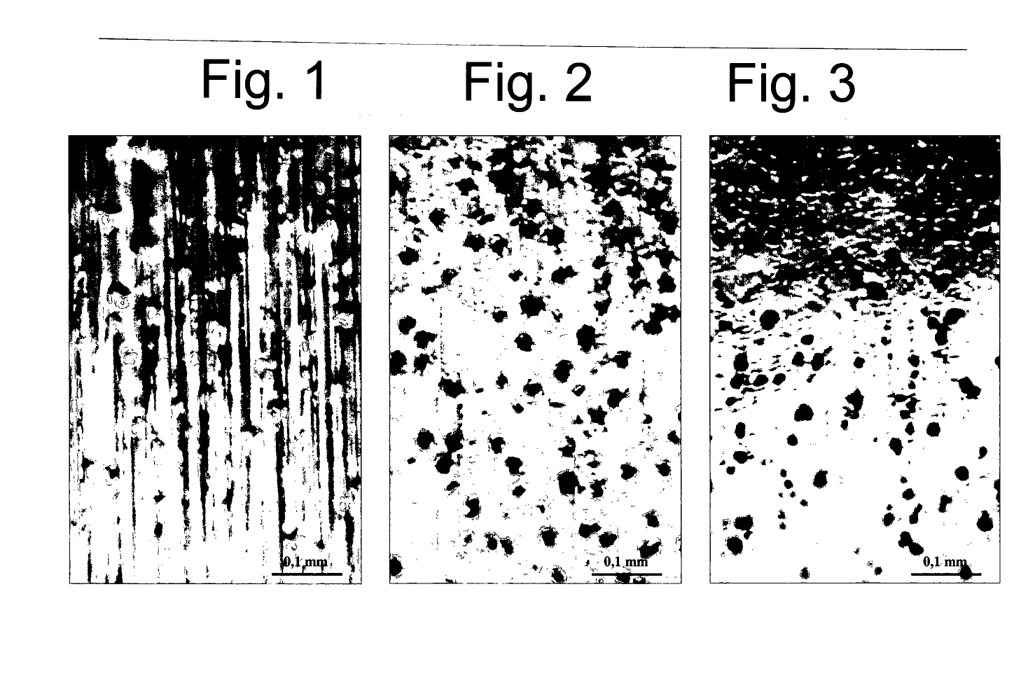

### DETAILED DESCRIPTION

Professionals in the relevant field will have sufficient knowledge of grinding and belt finishing bearing running surfaces. The same applies to the setting up of lasering and finish rolling processes for the bearing running surfaces. As such, there is no need to provide a description of these processes for this invention. The important thing is that conventional equipment is used and that this is present for a single machine or alone or combined for multiple machines. The best machine or machine combination for the job depends on the quantities being machined.

Irradiation with a laser beam simultaneously generates a martensitic outer layer around the irradiated bearing running surface. By changing the laser parameters, the depth of the thin martensitic outer layer on the surface can be defined as between 0.01 mm and 0.1 mm.

With the method accordingly the invention the quality of the running surfaces of the main and pin bearings of hardened or unhardened crankshafts made of cast steel after grinding or finishing the running surfaces is increased and therefore the life time of internal combustion engines is also increased.

1. A method for machining the surfaces of the bearing seats of main and pin bearings on crankshafts following the deburring of the surfaces with an undefined cutting edge by means of grinding or finishing, comprising the irradiation of surfaces using a laser beam.

2. The method according to claim 1, wherein the lasered surfaces are finish-rolled using a finishing tool.

3. The method according to claim 1, wherein a laser beam is used to create a martensitic outer layer with a depth of between 0.01 mm and 0.1 mm.

4. A method for processing the running surfaces of the main and pin main bearings of a crankshaft for an internal combustion engine, comprising:
belt finishing the surfaces;
laser machining the surfaces to create a martensitic outer layer on the surfaces having a depth of between about 0.01 mm and about 0.1 mm.

5. The method according to claim 4, further comprising:
finish rolling the surfaces.

6. A method for processing the running surfaces of the main and pin main bearings of a crankshaft for an internal combustion engine, comprising:
belt finishing the surfaces;
machining the surfaces to remove lids from the surface;
hardening the surfaces by creating a martensitic outer layer on the surfaces having a depth of between about 0.01 mm and about 0.1 mm; and
finish rolling the surfaces.
